(19) United States
(12) Patent Application Publication
(10) Pub. No.: US 2021/0252767 A1
(43) Pub. Date: Aug. 19, 2021

(54) ROLL-FORMING APPARATUS AND MANUFACTURING METHOD OF FIBER REINFORCED PLASTIC ROLL-FORMED PART

(71) Applicants: DAIDO KOGYO CO., LTD., Ishikawa (JP); KANAZAWA INSTITUTE OF TECHNOLOGY, Ishikawa (JP)

(72) Inventors: Takashi MAKARA, Ishikawa (JP); Yoshiki NAKAMURA, Ishikawa (JP); Kiyoshi UZAWA, Ishikawa (JP); Katsuhiko NUNOTANI, Ishikawa (JP)

(21) Appl. No.: 17/171,208

(22) Filed: Feb. 9, 2021

(30) Foreign Application Priority Data
Feb. 19, 2020 (JP) 2020-026595

(51) Int. Cl. B29C 53/04; B29C 53/84

(52) U.S. Cl. CPC B29C 53/043; B29C 53/84

(57) ABSTRACT

A roll-forming apparatus includes a heating portion, and a shaping portion disposed downstream of the heating portion in a conveyance direction of a fiber reinforced plastic member to shape the fiber reinforced plastic member heated by the heating portion. The shaping portion includes a first forming roller pair, and a second forming roller pair disposed downstream of the first forming roller pair in the conveyance direction. A rotational speed of the second forming roller pair is set higher than a rotational speed of the first forming roller pair to apply a tension in the conveyance direction to the fiber reinforced plastic member between the first forming roller pair and the second forming roller pair.

### BACKGROUND OF THE INVENTION

### Field of the Invention

The present invention relates to a roll-forming apparatus and to a method of manufacturing a fiber reinforced plastic roll-formed part.

### Description of the Related Art

There is widely known a processing method called roll-forming of forming a metal plate by passing the metal plate through a plurality of rollers. Because the roll-forming enables to continuously form the material by the plurality of rollers, the roll-forming excels in processing efficiency and is suited in forming a long member for example.

Meanwhile, while the roll-forming is widely used for materials that can be plastically processed such as the metallic material described above, it has been difficult to be applied to materials that cannot be plastically processed such as fiber reinforced plastic, e.g., fiber reinforced thermoplastic resin, which has been reinforced by laminating carbon fibers or glass fibers.

Then, there has been proposed a method of heating parts to be bent in such fiber reinforced plastic resin sheet in advance and of roll-forming the fiber reinforced plastic resin member partly heated as disclosed in Japanese Patent Application Laid-open No. H01-286823. The method as disclosed in Japanese Patent Application Laid-open No. H01-286823 improves processing accuracy of the bent part and prevents strength of the bent part from dropping.

However, in a case where roll-forming is performed on the fiber reinforced plastic member heated as disclosed in Japanese Patent Application Laid-open No. H01-286823, wrinkles are often generated in shaping the plastic because the plastic is shaped while the resin is in a molten state.

### SUMMARY OF THE INVENTION

According to a first aspect of the present invention, a roll-forming apparatus includes a heating portion configured to heat a fiber reinforced plastic member, and a shaping portion disposed downstream of the heating portion in a conveyance direction of the fiber reinforced plastic member to shape the fiber reinforced plastic member heated by the heating portion. The shaping portion includes a first forming roller pair configured to shape the fiber reinforced plastic member by passing the fiber reinforced plastic member heated by the heating portion between rollers of the first forming roller pair, and a second forming roller pair disposed downstream of the first forming roller pair in the conveyance direction and configured to shape the fiber reinforced plastic member shaped by the first forming roller pair between rollers of the second forming roller pair. A rotational speed of the second forming roller pair is set higher than a rotational speed of the first forming roller pair to apply a tension in the conveyance direction to the fiber reinforced plastic member between the first forming roller pair and the second forming roller pair.

According to a second aspect of the present invention, a manufacturing method of a fiber reinforced plastic roll-formed part, includes a heating step of heating a fiber reinforced plastic member, and a shaping step of roll-forming the fiber reinforced plastic member heated in the heating step by a first forming roller pair and a second forming roller pair disposed downstream of the first forming roller pair in the conveyance direction of the fiber reinforced plastic plate and having a rotational speed faster than that of the first forming roller pair while applying a tension to the fiber reinforced plastic member between the first and second forming roller pairs.

Further features of the present invention will become apparent from the following description of exemplary embodiments with reference to the attached drawings.

### BRIEF DESCRIPTION OF THE DRAWINGS

FIG. 1 is a schematic diagram illustrating a configuration of a roll-forming apparatus according to an exemplary embodiment of the invention.

FIG. 2 is a section view of a third forming roller pair

FIG. 3A illustrates a workpiece after being formed by a first forming roller pair.

FIG. 3B illustrates a workpiece after being formed by a second forming roller pair.

FIG. 3C illustrates a workpiece after being formed by the third forming roller pair.

FIG. 3D illustrates a state in which the workpieces as illustrated in FIGS. 3A through 3C are overlapped.

FIG. 4 is a section view illustrating a first cooling roller pair.

FIG. 5 is a block diagram illustrating a control portion.

FIG. 6 illustrates a workpiece sandwiched by thin-plate shims.

FIG. 7 illustrates a process of forming the workpiece sandwiched by the thin-plate shims.

### DESCRIPTION OF THE EMBODIMENTS

### First Exemplary Embodiment

Configuration of roll-forming apparatus

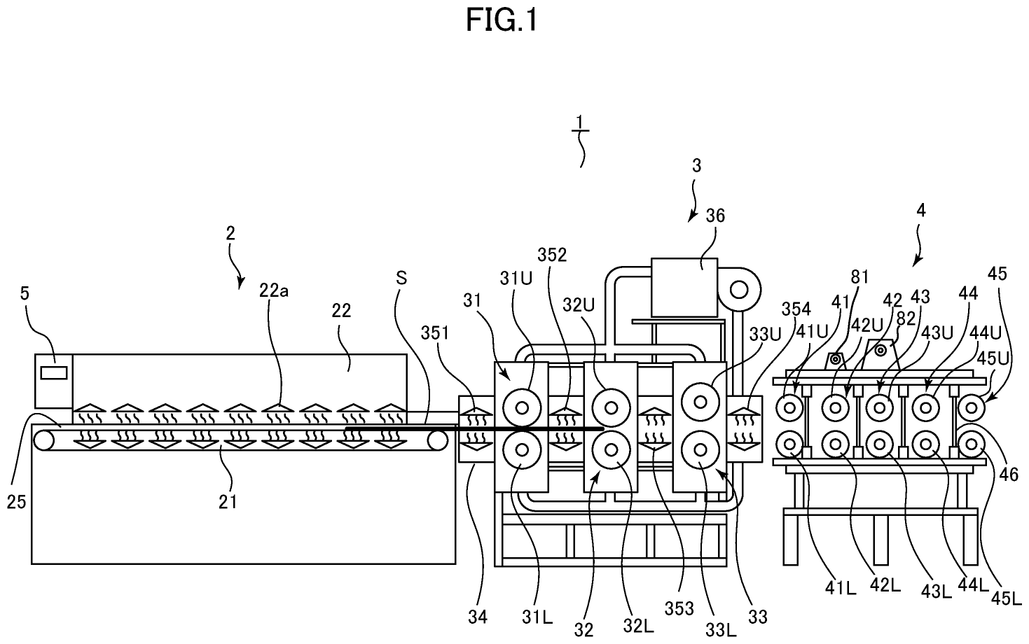

A roll-forming apparatus 1 according to a first exemplary embodiment of the invention will be described with reference to FIGS. 1 through 5. As illustrated in FIG. 1, the roll-forming apparatus 1 is an apparatus for roll-forming a workpiece S formed of fiber reinforced plastic (FRP) materials such as carbon fiber reinforced plastic (CFRP), glass fiber reinforced plastic (GFRP) and boron fiber reinforced plastic (BFRP). The fiber reinforced plastic plate may be formed by laminating fiber reinforced plastic sheets or formed of a single fiber reinforced plastic sheet. The fiber reinforced plastic sheet includes fibers and resin. Examples of the fibers include fibers such as carbon fibers, glass fibers, and boron fibers. The fibers are made from fibers such as continuous fibers, long fibers and short fibers. Orientations of the fibers includes unidirectional (UD), woven, and random. Examples of the resins include thermoplastic resins such as polypropylene (PP), polyamide (PA), and poly ether ether ketone (PEEK). Thickness of the single fiber reinforced plastic sheet is from 0.1 mm to 2 mm, for example.

The roll-forming apparatus 1 includes a heating portion 2, a shaping portion 3 and a cooling portion 4 disposed along a conveyance direction of the workpiece S and forms the workpiece S by passing through the heating portion 2, the shaping portion 3 and the cooling portion 4 in this order to manufacture a fiber reinforced plastic roll-formed part.

The heating portion 2 also includes a conveyance unit 21 that conveys the workpiece S and a heating unit 22 that heats the workpiece S conveyed by the conveyance unit 21. More specifically, according to the present exemplary embodiment, the conveyance unit 21 is composed of a belt conveyer unit. The heating unit 22 also includes a plurality of hollow-plate type infrared ceramic heaters 22a arrayed in the conveyance direction of the workpiece S to heat the workpiece S being conveyed on the belt conveyor described above from upper and lower directions.

The shaping portion 3 includes a plurality of forming roller pairs 31 through 33 arrayed in the conveyance direction of the workpiece S, and the workpiece S is gradually formed into a desirable shape while being passed through between these plurality of forming roller pairs 31 through 33. More specifically, according to the present exemplary embodiment, the shaping portion 3 includes the first through third forming roller pairs 31 through 33. The forming roller pairs 31 through 33 include upper roll portions 31U through 33U and lower roll portions 31L through 33L, respectively. Note that because the first through third forming roller pairs 31 through 33 have the same configuration except that shapes of their forming dies are different, only the configuration of the third forming roller pair 33 will be described and the configurations of the first and second forming roller pairs 31 and 32 will be omitted in the following description.

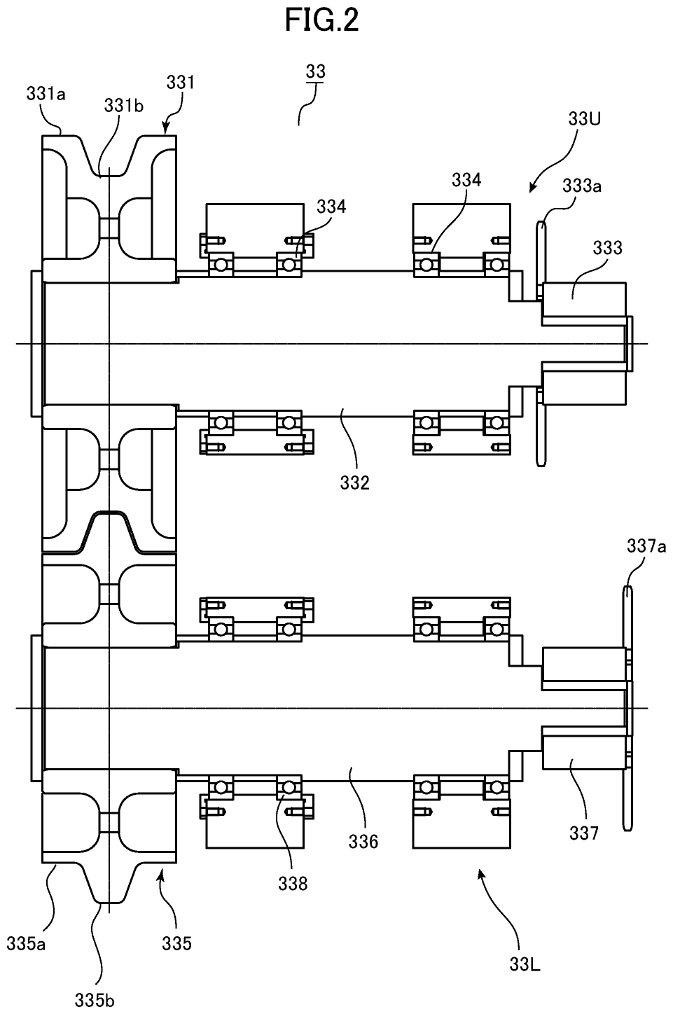

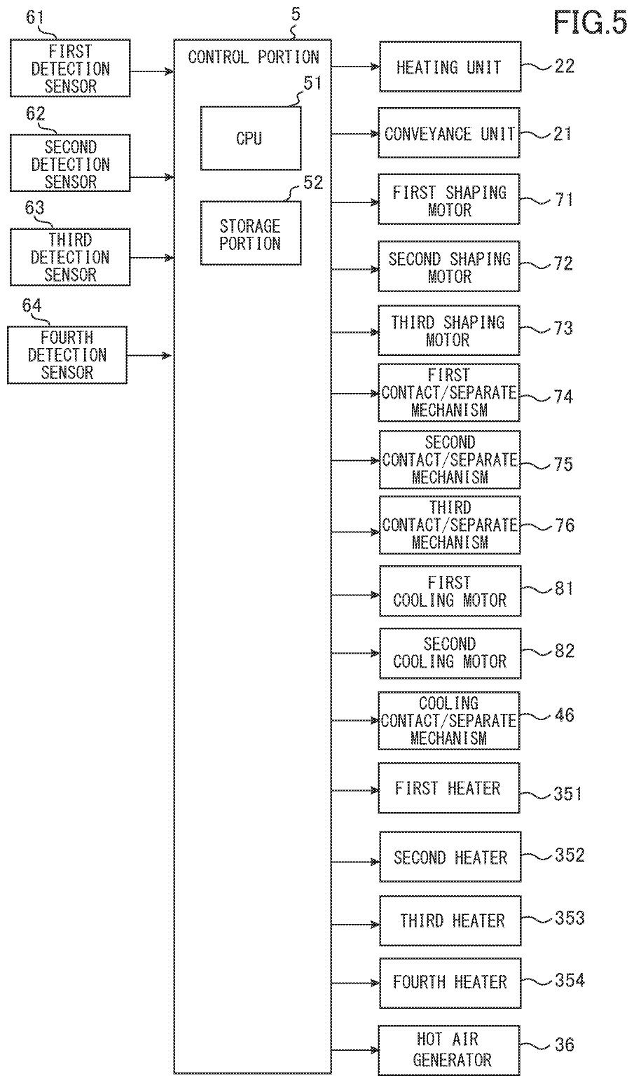

As illustrated in FIG. 2, the upper roll portion 33U of the third forming roller pair 33 is composed of an upper forming roller 331 serving as a roll forming die configured to shape the workpiece S and attached at one end of a rotary shaft 332 rotatably supported by bearings 334. A sprocket 333a is provided at another end of the rotary shaft 332 through a cam clutch 333, and the rotary shaft 332 is rotated by a driving force inputted to the sprocket 333a from a third shaping motor 73 (see FIG. 5) through a chain.

In the same manner, the lower roll portion 33L of the third forming roller pair 33 is composed of a lower forming roller 335 serving as a roll forming die configured to shape the workpiece S and attached at one end of a rotary shaft 336 rotatably supported by a bearing 338. A sprocket 337a is provided at another end of the rotary shaft 336 through a cam clutch 337, and the rotary shaft 336 is rotated by a driving force inputted to the sprocket 337a from the third shaping motor 73 through a chain.

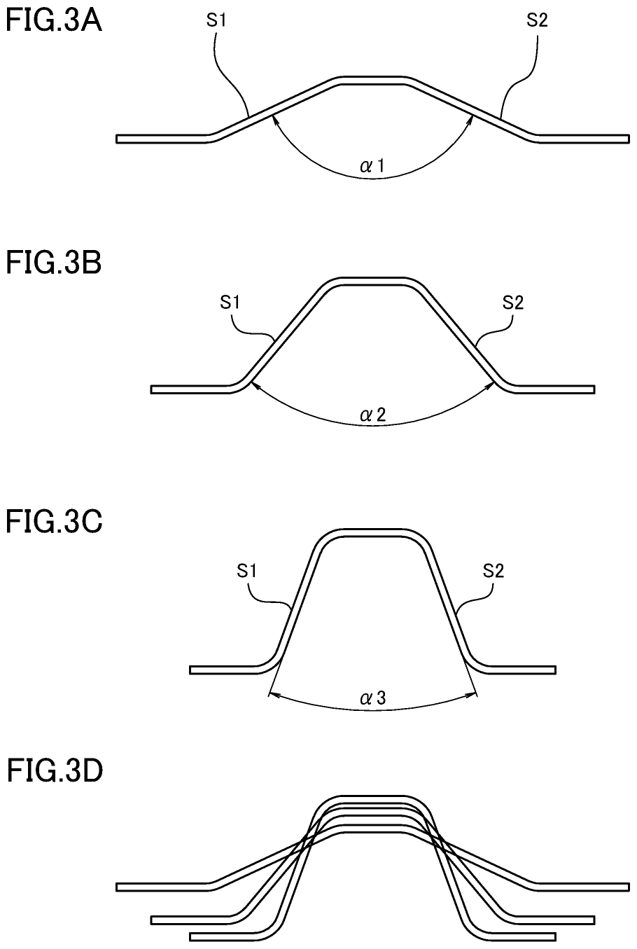

The upper forming roller 331 of the upper roll portion 33U and the lower forming roller 335 of the lower roll portion 33L have shapes corresponding to each other, and one forming die is composed of the upper forming roller 331 and the lower forming roller 335 engaging with each other. Note that the upper forming roller 331 and the lower forming roller 335 as illustrated in FIG. 2 are roll forming dies for forming a sheet-like fiber reinforced plastic member (referred simply as a ‘fiber reinforced plastic plate’ hereinafter) into a shape of a hat as illustrated in FIG. 3C. The fiber reinforced plastic plate heated by the heating portion 2 is formed into a shape as illustrated in FIG. 3A by being passed through between the first forming roller pair 31 and is then formed into a shape as illustrated in FIG. 3B by being passed through between the second forming roller pair 32. Then, the fiber reinforced plastic plate is formed into the shape as illustrated in FIG. 3C by being passed through between the third forming roller pair 33. As illustrated in FIG. 3D, the fiber reinforced plastic plate serving as the workpiece S is formed such that a bending angle thereof gradually increases by being passed sequentially through the first through third forming roller pairs 31 through 33. That is, the fiber reinforced plastic plate is formed such that an angle between left and right bending portions S1 and S2 gradually decreases by being sequentially passed through the first through third forming roller pairs 31 through 33, i.e., α1>α2>α3.

The shaping portion 3 also includes a shaping portion cover 34 that covers the first through third forming roller pairs 31 through 33 and the conveyance path of the workpiece S described above (see FIG. 1). Still further, a first heater 351 is provided between the heating portion 2 and the first forming roller pair 31 within the shaping portion cover 34, a second heater 352 is provided between the first forming roller pair 31 and the second forming roller pair 32, a third heater 353 is provided between the second forming roller pair 32 and the third forming roller pair 33 and a fourth heater 354 is provided between the third forming roller pair 33 and the cooling portion 4. Therefore, an inside of the shaping portion cover 34 becomes a heating chamber that heats the workpiece S, so that temperature of the workpiece S which has dropped by being in contact with the first through third forming roller pairs 31 through 33 described above can be restored up to melting temperature.

The shaping portion 3 also includes a hot air generator 36 that blows hot air within the chamber in which these first through third forming roller pairs 31 through 33 are disposed to reduce the temperature drop of the workpiece S that is caused by the contact with the first through third forming roller pairs 31 through 33.

The cooling portion 4 is provided downstream of the shaping portion 3 in the conveyance direction of the workpiece S and includes a plurality of cooling roller pairs 41 through 45 in the conveyance direction. More specifically, according to the present exemplary embodiment, the cooling portion 4 includes the first through fifth cooling roller pairs 41 through 45 and a cooling contact/separate mechanism 46 configured to contact/separate upper and lower rollers 411 through 451 and 415 through 455 of the first through fifth cooling roller pairs 41 through 45. Note that because the first through fifth cooling roller pairs 41 through 45 have the same configuration, only the configuration of the first cooling roller pair 41 will be described and descriptions of the configurations of the second through fifth cooling roller pair 42 through 45 will be omitted in the following description.

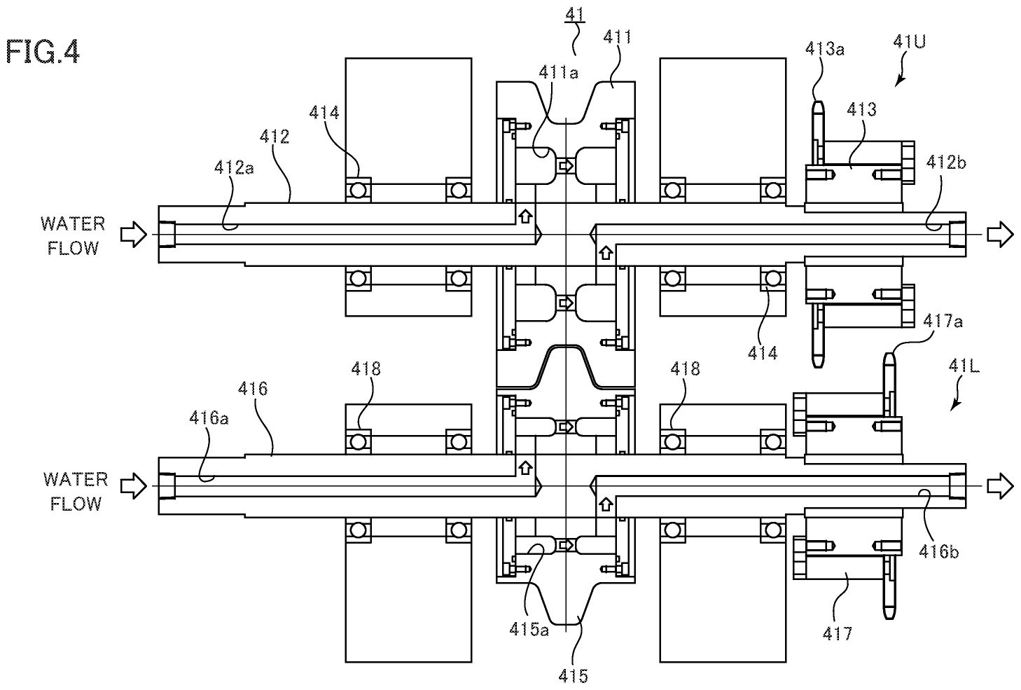

As illustrated in FIG. 4, an upper roll portion 41U of the first cooling roller pair 41 includes an upper cooling roller 411 that is fixedly attached to a rotary shaft 412 rotatably supported by bearings 414. The upper cooling roller 411 is positioned between right and left bearings 414, and a sprocket 413a is provided at one end portion of the rotary shaft 412 through a cam clutch 413. The rotary shaft 412 is rotated by a driving force inputted from a first cooling motor 81 to the sprocket 413a.

Channels 412a and 412b for passing refrigerant, i.e., cooling water in the present exemplary embodiment, are perforated through a center of the rotary shaft 412. Among the channels in the rotary shaft 412, the upstream channel 412a is connected to a channel 411a formed inside of the upper cooling roller 411, and the refrigerant flowing through the channel 412a flows into the channel 411a of the upper cooling roller 411 to cool the upper cooling roller 411. The channel 411a of the upper cooling roller 411 is also connected with the downstream channel 412b of the rotary shaft 412, and the refrigerant flown into the channel 411a is passed through the downstream channel 412b of the rotary shaft 412 to be discharged. The upper cooling roller 411 has a shape corresponding to the shape of an upper surface side of the workpiece S shaped by the shaping portion 3 and conveys the workpiece S while cooling the workpiece S by coming into contact with the upper surface of the workpiece S.

In the same manner, a lower roll portion 41L of the first cooling roller pair 41 includes a lower cooling roller 415 that is fixedly attached to a rotary shaft 416 rotatably supported by bearings 418. The lower cooling roller 415 is positioned between right and left bearings 418, and a sprocket 417a is provided at one end portion of the rotary shaft 416 through a cam clutch 417. The rotary shaft 416 is rotated by a driving force inputted from the driving source 81 to the sprocket 417a.

Channels 416a and 416b for passing refrigerant, i.e., water in the present exemplary embodiment, are perforated through a center of the rotary shaft 416. Among the channels in the rotary shaft 416, the upstream channel 416a is connected to a channel 415a formed inside of the lower cooling roller 415, and the refrigerant flowing through the rotary shaft 416a flows into the channel 415a of the lower cooling roller 415 to cool the lower cooling roller 415. The channel 415a of the lower cooling roller 415 is also connected with the downstream channel 416b of the rotary shaft 416, and the refrigerant flown into the channel 415a is passed through the downstream channel 416b of the rotary shaft 416 to be discharged. The lower cooling roller 415 has a shape corresponding to the shape of a lower surface side of the workpiece S shaped by the shaping portion 3 and conveys the workpiece S while cooling the workpiece S by coming into contact with the lower surface of the workpiece S.

As illustrated in FIG. 5, a control portion 5 of the roll-forming apparatus 1 includes a CPU 51 serving as an operating portion and a storage portion 52 including a ROM and a RAM. The control portion 5 is also connected with a first detection sensor 61 that detects the workpiece S between the heating portion 2 and the first forming roller pair 31, a second detection sensor 62 that detects the workpiece S between the first forming roller pair 31 and the second forming roller pair 32, a third detection sensor 63 that detects the workpiece S between the second forming roller pair 32 and the third forming roller pair 33 and a fourth detection sensor 64 that detects the workpiece S between the third forming roller pair 33 and the cooling portion 4 to receive signals from the respective sensors.

The control portion 5 is also connected with the conveyance unit 21 and the heating unit 22 of the heating portion 2 to be able to control a conveyance speed, i.e., a feed speed, and heating temperature of the workpiece S in the heating portion 2.

The control portion 5 is also connected with first through third shaping motors 71 through 73 that drive the first through third forming roller pairs 31 through 33 of the shaping portion 3, with first through third contact/separate mechanisms 74 through 76 that bring the first through third forming roller pairs 31 through 33 into a contact state/a separate state, respectively, with first through fourth heaters 351 through 354 and with the hot air generator 36. Thereby, the control portion 5 can control the conveyance speed of the workpiece S, the heating temperature and contact/separate timings of the first through third forming roller pairs 31 through 33 in the shaping portion 3.

Note that the upper and lower forming rollers 311 through 331 and 315 through 355 of the first through third forming roller pairs 31 through 33 are separated until when the workpiece S comes to be conveyed. As the first through third detection sensors 61 through 63 detect a leading edge of the workpiece S, the control portion 5 controls the first through third contact/separate mechanisms 74 through 76 to lower the upper forming rollers 311 through 331 to come to bottom dead points at timing when the leading edge of the workpiece S arrives at the first through third forming roller pairs 31 through 33.

The control portion 5 is also connected with the first cooling motor 81 that drives the first cooling roller pair 41 of the cooling portion 4, a second cooling motor 82 that drives the second through fifth cooling roller pairs 42 through 45 and a cooling contact/separate mechanism 46 that contacts/separates these first through fifth cooling roller pairs 41 through 45, and is arranged to be able to control a conveyance speed of the workpiece S in the cooling portion 4 and contact/separate timings of the first through fifth cooling roller pairs 41 through 45. Note that the first through fifth cooling roller pairs 41 through 45 stand by in the separate state until when the workpiece S comes to be conveyed, and the control portion 5 controls the cooling contact/separate mechanism 46 based on the detection of the leading edge of the workpiece S detected by the fourth detection sensor 64 described above to lower the upper cooling rollers 411 through 451 of the first through fifth cooling roller pairs 41 through 45 to come to the bottom dead point at timing when the leading edge of the workpiece S arrives at the first cooling roller pair 41.

### Manufacturing Method of Fiber Reinforced Plastic Roll-Formed Part

Next, a method for manufacturing the fiber reinforced plastic roll-formed part by using the roll-forming apparatus 1 described above will be described. In manufacturing the fiber reinforced plastic roll-formed part, the fiber reinforced plastic roll-formed part undergoes a heating step, a shaping step and a cooling step.

At first, an operator inputs a fiber reinforced plastic plate S serving as the workpiece S to the heating portion 2 from an input port 25 (see FIG. 1). When the fiber reinforced plastic plate S is inputted, the heating portion 2 conveys the fiber reinforced plastic plate S to a middle portion of the heating portion 2 and then stops. Then, in the heating step, the heating portion 2 heats up the fiber reinforced plastic plate S to temperature equal to or higher than resin melting temperature and equal to or lower than thermal decomposition temperature for a predetermined period of time while keeping the stop state. Then, as the predetermined period of time elapses and the fiber reinforced plastic plate S is heated up to the temperature equal to or higher than the melting temperature, the heating portion 2 conveys the heated fiber reinforced plastic plate S again toward the shaping portion 3.

Note that in a case where a carbon fiber reinforced plastic of “resin: polyamide 6, fiber: carbon fiber, size of fiber bundle: 12 K, weaving method: plain weave, rate of fiber within whole volume VF: 50%” is used as the fiber reinforced plastic plate for example, the melting temperature is 214° C., recrystallization temperature is 189 to 193° C. and the thermal decomposition temperature is 310° C. A reason while the recrystallization temperature has a difference of 189 to 193° C. is that the faster the temperature dropping speed, the more the recrystallization temperature shifts to a low temperature side.

After finishing the step of heating the fiber reinforced plastic plate S by the heating portion 2, the fiber reinforced plastic plate S is conveyed then to the shaping portion 3. The workpiece S that has come to be conveyed to the shaping portion 3 advances to the first forming roller pair 31 while being heated up by the first heater 351. Then, the fiber reinforced plastic plate S is shaped by the first forming roller pair 31 into the shape as illustrated in FIG. 3A while being conveyed downstream.

The fiber reinforced plastic plate S formed by the first forming roller pair 31 advances to the second forming roller pair 32 while recovering the temperature that has dropped by coming into contact with the first forming roller pair 31 by a second heater 352. A rotational speed of the second forming roller pair 32 is set to be faster than that of the first forming roller pair 31, e.g., the rotational speed of the second forming roller pair 32 is faster than that of the first forming roller pair 31 by five percent in the present exemplary embodiment, and the fiber reinforced plastic plate S is shaped by the first and second forming roller pairs 31 and 32 in a state in which a tension is applied to the fiber reinforced plastic plate S between the first and second forming roller pairs 31 and 32 (see FIG. 3B).

In the same manner, the fiber reinforced plastic plate S shaped by the second forming roller pair 32 advances to the third forming roller pair 33 while recovering the temperature that has dropped by coming into contact with the second forming roller pair 32 by a third heater 353. A rotational speed of the third forming roller pair 33 is set to be faster than that of the second forming roller pair 32, e.g., the rotational speed of the third forming roller pair 33 is faster than that of the second forming roller pair 32 by five percent in the present exemplary embodiment, and the fiber reinforced plastic plate S is shaped by the second and third forming roller pairs 32 and 33 in a state in which a tension is applied to the fiber reinforced plastic plate S between the second and third forming roller pairs 32 and 33 (see FIG. 3C).

Because the shaping step of the fiber reinforced plastic plate S is executed within the heating chamber covered by the shaping portion cover 34 in the shaping portion 3, the temperature dropping speed of the fiber reinforced plastic plate S is delayed during the shaping step. While the faster the temperature dropping speed described above, the lower the recrystallization temperature of the fiber reinforced plastic plate S is, a shift width to the lower temperature side of the recrystallization temperature is small and a long formable time can be kept when the temperature dropping speed is slowed as compared to a case where the temperature dropping speed is set faster.

Still further, while the fiber reinforced plastic plate S is liable to be influenced from outside and tends to cause wrinkles because the fiber reinforced plastic plate S during forming is in a state in which the resin melts and is softened, the wrinkles are suppressed from being generated because the tension in the conveyance direction is applied to the fiber reinforced plastic plate S between the first through third forming roller pairs 31 through 33 as described above.

Still further, if a difference of rotational speeds is created among the first through third forming roller pairs 31 through 33, a slip is generated between the contact surface of the forming rollers and the surface of the fiber reinforced plastic plate S by the difference of the rotational speeds. If such slip is generated, a friction is generated between the contact surface of the forming rollers and the surface of the fiber reinforced plastic plate S, and there is a possibility of disarranging orientation of fibers of the fiber reinforced plastic plate S. However, according to the present exemplary embodiment, the cam clutches 313 through 333 and 317 through 337 are provided to each of the upper and lower forming rollers 311 through 331 of the first through third forming roller pairs 31 through 33. That is, the cam clutches 313 through 333 and 317 through 337 become torque limiting portions that limit back torque inputted from the fiber reinforced plastic plate S′ to driving paths, i.e., power transmission paths between the respective forming rollers and the driving source, of the respective forming rollers 311 through 331. Therefore, as the fiber reinforced plastic plate S is nipped across the first through third forming roller pairs 31 through 33 and the fiber reinforced plastic plate S is conveyed by being pulled by the third forming roller pair 33 for example, the cam clutches 313 through 317 of the first forming roller pair 31 idle and the first forming roller pair 31 is driven by the fiber reinforced plastic plate S before the fiber reinforced plastic plate S causes a large slip between the first forming roller pair 31. Thus, the slip between the first forming roller pair 31 and the fiber reinforced plastic plate S is suppressed.

In the same manner, even in a case where the slip between the first forming roller pair 31 and the fiber reinforced plastic plate S increases due to a difference of speeds between the first forming roller pair 31 and the second forming roller pair 32, the cam clutches 313 and 317 idle, and the first forming roller pair 31 is driven by the fiber reinforced plastic plate S. Thus, the slip between the first forming roller pair 31 and the fiber reinforced plastic plate S is suppressed.

Still further, in a case where the slip between the second forming roller pair 32 and the fiber reinforced plastic plate S increases due to a difference of speeds of the second forming roller pair 32 and the third forming roller pair 33, the cam clutches 323 and 327 idle, and the second forming roller pair 32 is driven by the fiber reinforced plastic plate S. Thus, the slip between the second forming roller pair 32 and the fiber reinforced plastic plate S is suppressed.

In addition, the upper and lower forming rollers 311 through 331 and 315 through 335 of the first through third forming roller pairs 31 through 33 described above have different shapes because they are forming dies of the fiber reinforced plastic plate S, and a difference of circumferential speeds is generated among these forming rollers 311 through 331 and 315 through 335. That is, in a case where the upper forming roller 311 and the lower forming roller 335 as illustrated in FIG. 2 are exemplified, they are designed such that the circumferential speeds coincide by flange forming portions 331a and 335a forming a hat-shape flange portions. Meanwhile, concave portion 331b of the upper forming roller 331 forming a hat-shape crown portion and a convex portion 335b of the lower forming roller 335 differ in terms of outer diameters, so that a difference of circumferential speed is generated.

While a slip may be generated between the respective forming rollers and the fiber reinforced plastic plate S due to the difference of circumferential speeds among the upper and lower forming rollers 311 through 331 and 315 through 335, it is possible to minimize the slip by idling the forming rollers by the cam clutches 313 through 333 and 317 through 337 because they are provided in all of the upper and lower forming rollers 311 through 331 and 315 through 335.

The fiber reinforced plastic plate S shaped by the shaping portion 3 is conveyed to the cooling portion 4 by the third forming roller pair 33. Specifically, the fiber reinforced plastic plate S conveyed to the cooling portion 4 by the third forming roller pair 33 is conveyed downstream while being cooled by the first cooling roller pair 41. Note that a rotational speed of the first cooling roller pair 41 is faster than that of the third forming roller pair 33, and the fiber reinforced plastic plate S is cooled by the first cooling roller pair 41 in a state in which a tension is applied to the fiber reinforced plastic plate S between the third forming roller pair 33 and the first cooling roller pair 41.

The fiber reinforced plastic plate S cooled by the first cooling roller pair 41 advances to the second cooling roller pair 42 and is conveyed downstream by the second cooling roller pair 42. A rotational speed of the second cooling roller pair 42 is faster than that of the first cooling roller pair 41, and the fiber reinforced plastic plate S is cooled by the first cooling roller pair 41 in a state in which a tension is applied between the first cooling roller pair 41 and the second cooling roller pair 42. Then, the fiber reinforced plastic plate S is conveyed sequentially by the third and fifth cooling roller pairs 43 through 45 and is finally discharged as the fiber reinforced plastic roll-formed part by being cooled down below the resin recrystallization temperature. Note that the rotational speeds of the third through fourth cooling roller pairs 43 through 45 are the same with that of the second cooling roller pair 41, and the rotational speeds of the second through fifth cooling roller pairs 42 through 45 are faster than the rotational speed of the first cooling roller pair 41 by five percent.

Because the cooling portion 4 thus cools the fiber reinforced plastic plate S while applying the tension to the fiber reinforced plastic plate S between the cooling roller pairs in the same manner with the shaping portion 3 in the present exemplary embodiment, it is possible to suppress wrinkles from being generated in cooling the fiber reinforced plastic plate S. Still further, because the upper and lower cooling rollers 411 through 451 and 415 through 455 are provided respectively with cam clutches 413 through 453 and 417 through 457, it is possible to reduce the slip between the fiber reinforced plastic plate S and the first cooling roller pair 41 otherwise caused by the difference of the rotational speeds between the first cooling roller pair 41 and the second through fifth cooling roller pairs 42 through 45. Still further, the slip between the fiber reinforced plastic plate S and the cooling rollers 411 through 451 and 415 through 455 otherwise caused by the difference of circumferential speeds caused by the difference of shapes of the cooling rollers 411 through 451 and 415 through 455 can be minimized.

While two rollers of each roller pair of the first through third forming roller pairs 31 through 33 have been driven respectively by one of the motors 71 through 73 in the exemplary embodiment described above, the two rollers may be driven by different motors independent of each other by providing a motor for each roller of the respective roller pairs. That is, the driving source of the roller pairs may be composed of one motor driving two rollers or may be composed of a plurality of motors provided per each roller. Still further, the driving source may be composed of motors that drive only rollers of one side of a plurality of roller pairs and that drives only rollers of another side or the motors, or the motors may be commonized between the plurality of roller pairs, provided that the driving source includes a transmission mechanism.

The first through fifth cooling roller pairs 41 through 45 may be provided also with motors per roller of each roller pair to drive each roller of the cooling roller pair by the separate and independent motor. Still further, the driving source may be composed of a motor that drives only roller of one side of a plurality of roller pairs and that drives only roller of another side, provided that the driving source includes a transmission mechanism.

### Conclusion

As described above, the roll-forming apparatus 1 of the present exemplary embodiment includes:

the heating portion 2 configured to heat the fiber reinforced plastic member S; and

the shaping portion 3 disposed downstream of the heating portion 2 in the conveyance direction of the fiber reinforced plastic member S to shape the fiber reinforced plastic member S heated by the heating portion 2;

wherein the shaping portion 3 includes

the first forming roller pair 31 configured to form the fiber reinforced plastic member S by passing the fiber reinforced plastic member S heated by the heating portion 2 between the rollers of the first forming roller pair, and

the second forming roller pair 32 disposed downstream of the first forming roller pair 31 in the conveyance direction and configured to form the fiber reinforced plastic member S formed by the first forming roller pair by passing between rollers of the second forming roller pair; and

wherein a rotational speed of the second forming roller pair 32 is set to be higher than a rotational speed of the first forming roller pair 31 to apply a tension in the conveyance direction to the fiber reinforced plastic member between the first forming roller pair 31 and the second forming roller pair 32.

Due to that, the fiber reinforced plastic member serving as the workpiece heated by the heating portion 2 can be shaped in the state in which the tension is applied to the fiber reinforced plastic member between the first and second forming roller pairs 31 and 32, so that it is possible to suppress wrinkles from being generated in shaping the fiber reinforced plastic member and to improve quality of the product.

The first forming roller pair 31 includes first and second forming rollers 331 and 335 disposed so as to face with each other to shape the fiber reinforced plastic member S, and wherein

the roll-forming apparatus 1 further includes:

the driving source 71 configured to rotationally drive the first forming roller 331; and

the torque limiting portion 333 configured to limit back torque inputted from the fiber reinforced plastic member S to the driving path of the first forming roller 331.

More specifically, according to the present exemplary embodiment, the roll-forming apparatus 1 includes a one-way clutch 333 disposed in a driving path of the first forming roller 331 and configured to transmit a rotational force from the driving source in a direction in which the first forming roller rotates in a first direction of conveying the fiber reinforced plastic member downstream in the conveyance direction and to idle in a direction in which the first forming roller 331 rotates in a second direction opposite to the first direction.

Because the one-way clutch 333 serving as the torque limiting portion limits back torque, i.e., torque that rotates the first forming roller 331 in the second direction, inputted from the fiber reinforced plastic member to the driving path of the first forming roller 331, it is possible to suppress the fiber reinforced plastic member from slipping with respect to the first forming roller 331 by a difference of the rotational speeds of the first and second forming roller pairs 31 and 32. Therefore, it is possible to prevent orientation of fibers of the fiber reinforced plastic member from being disturbed otherwise caused by the slip of the fiber reinforced plastic member with respect to the first forming roller 331.

The roll-forming apparatus 1 further includes a one-way clutch 337 that is configured to transmit a rotational force from the driving source 71 in a direction in which the second forming roller 335 rotates in a third direction in which the fiber reinforced plastic member is conveyed downstream in the conveyance direction and to ide in a direction in which the second forming roller 335 rotates in a fourth direction opposite to the third direction.

Thus, it is possible to suppress the slip from being generated between the fiber reinforced plastic member and the first forming roller 331 or the lower forming roller 335 due to the difference of shapes of the first and second forming rollers 331 and 335 by providing the one-way clutches 333 and 337 serving as the torque limiting portions to all of the first and second forming rollers 331 and 335. Note that the driving source of the first forming roller pair may include separate motors for the first and second forming rollers as described above. In this case, the one-way clutch is disposed on a driving path through which power from each driving source is transmitted.

Note that while the one-way clutches 333 and 337 are provided for both of the first and second forming rollers 331 and 335 in the present exemplary embodiment, these one-way clutches 333 and 337 may be provided for either one of the first and second forming rollers 331 and 335. Still further, while the upper forming roller of the forming roller pair has been described as the first forming roller and the lower forming roller as the second forming roller for convenience in the above description, the upper forming roller may be the second forming roller and the lower forming roller may be the first forming roller.

Still further, while the cam clutches 333 and 337 have been described as one example of the one-way clutches in the present exemplary embodiment, the one-way clutch may be formed by a sprag system. Still further, the torque limiting portion may be composed of not only the one-way clutch but also by a slipper clutch and the like.

Still further, the shaping portion 3 includes the heater 352 configured to heat the fiber reinforced plastic member S between the first and second forming roller pairs 31 and 32.

Therefore, it is possible to restore temperature of the fiber reinforced plastic member that has dropped by coming into contact with the first forming roller pair 31 by heating by the heater 352 and to improve formability of the fiber reinforced plastic member in the second forming roller pair 32.

The roll-forming apparatus 1 further includes the cooling portion 4 disposed downstream of the shaping portion 3,

wherein the cooling portion 4 includes an upstream cooling roller pair 41 configured to cool the fiber reinforced plastic member S shaped by the shaping portion 3 by passing the fiber reinforced plastic member between rollers thereof, and

a downstream cooling roller pair 42 disposed downstream of the upstream cooling roller pair 41 in the conveyance direction and configured to cool the fiber reinforced plastic member cooled by the upstream cooling roller pair 41 by passing between rollers thereof, and

wherein a rotational speed of the downstream cooling roller pair 42 is set to be higher than a rotational speed of the upstream cooling roller pair 41 to apply a tension in the conveyance direction to the fiber reinforced plastic member S between the upstream cooling roller pair 41 and the downstream cooling roller pair 42.

It is possible to suppress wrinkles from being generated in cooling the fiber reinforced plastic member by cooling the fiber reinforced plastic member while applying the tension between the upstream cooling roller pair 41 and the downstream cooling roller pair 42.

Still further, the upstream cooling roller pair 41 includes first and second cooling rollers 411 and 415 disposed so as to face with each other, and

the roll-forming apparatus 1 further includes a driving source 81 configured to rotationally drive the upstream cooling roller pair 41, and

a one-way clutch 413 disposed in a driving path of the first cooling roller 411 and configured to transmit a rotational force from the driving source 81 in a case where the first cooling roller 411 rotates in a direction of conveying the fiber reinforced plastic member S downstream in the conveyance direction and to idle in a case where the first cooling roller 411 rotates in a direction opposite to the direction in which the first cooling roller 411 conveys the fiber reinforced plastic member S downstream in the conveyance direction.

Thus, because the one-way clutch 413 is provided as the torque limiting portion that limits back torque otherwise inputted from the fiber reinforced plastic member, it is possible to suppress the slip between the fiber reinforced plastic member and the first cooling roller 411 otherwise caused by a difference of rotational speeds of the upstream cooling roller pair 41 and the downstream cooling roller pair 42.

The roll-forming apparatus 1 also includes a one-way clutch 417 disposed in a driving path of the lower cooling roller 415 and configured to transmit a rotational force from the driving source 81 in a case where the lower cooling roller 415 rotates in a direction of conveying the fiber reinforced member S downstream in the conveyance direction and to idle in a case where the lower cooling roller 415 rotates in a direction opposite to the direction of conveying the fiber reinforced plastic member S downstream in the conveyance direction.

Thereby, it is possible to suppress the slip from being generated between the first cooling roller 411 or the lower cooling roller 415 and the fiber reinforced plastic member otherwise caused by the difference of circumferential speeds caused by the difference of shapes of the first and second cooling rollers 411 and 415.

A manufacturing method of a fiber reinforced plastic roll-formed part of the present exemplary embodiment includes:

a heating step of heating the fiber reinforced plastic member S; and

a shaping step of roll-forming the fiber reinforced plastic member heated in the heating step by the first and second forming roller pairs 31 and 32 while applying a tension to the fiber reinforced plastic member between the first forming roller pair 31 and the second forming roller pair 32 disposed downstream of the first forming roller pair 31 in the conveyance direction of the fiber reinforced plastic member S and having a rotational speed faster than that of the first forming roller pair 31.

This arrangement makes it possible to shape the fiber reinforced plastic member serving as a workpiece heated by the heating portion 2 while applying the tension to the fiber reinforced plastic member between the first and second forming roller pairs 31 and 32, to suppress wrinkles from being generated in the fiber reinforced plastic member in forming the fiber reinforced plastic member and to improve quality of the product.

### Second Exemplary Embodiment

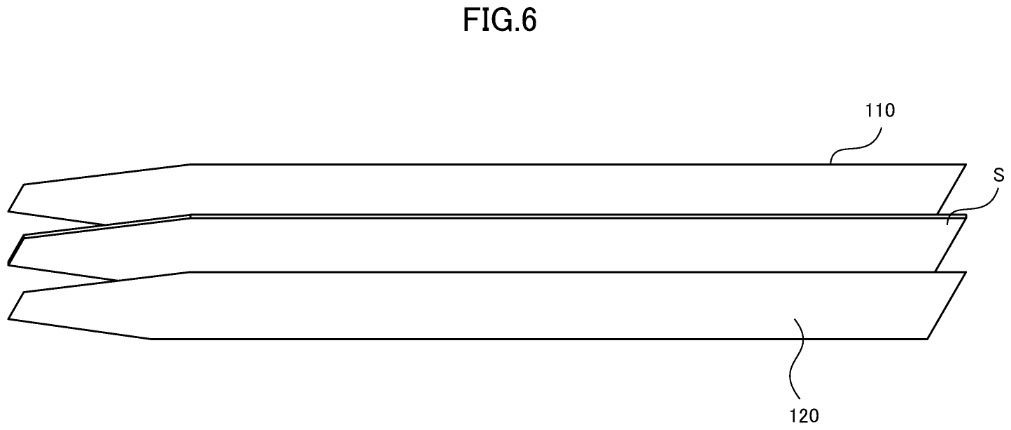

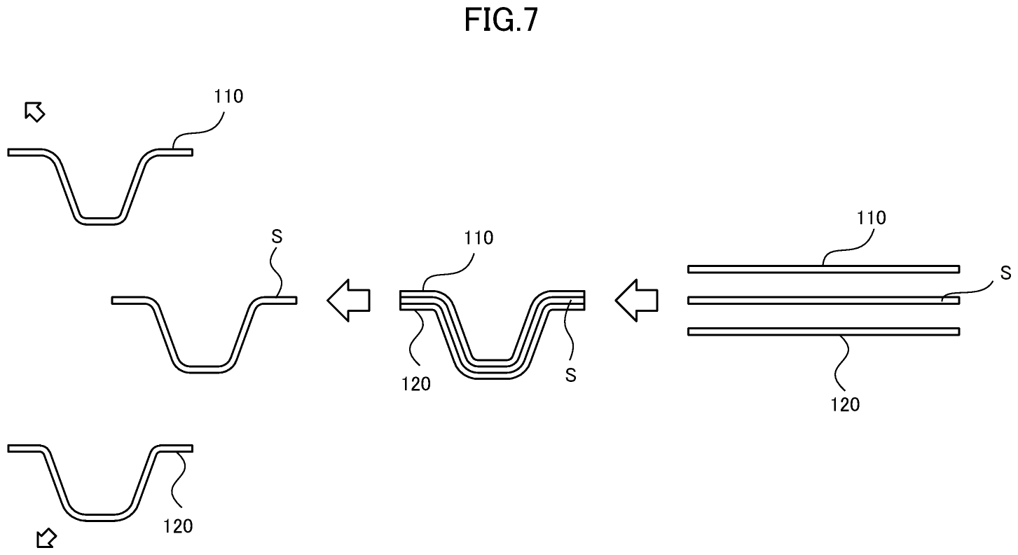

Next, a second exemplary embodiment of the present disclosure will be described with reference to FIGS. 6 and 7. Note that the second embodiment is different from the first embodiment described above in that a preparation step of sandwiching the fiber reinforced plastic member by thin plate shims (referred to also as a ‘shim plate’ hereinafter) is provided. Accordingly, only points different from the first embodiment will be described and others will be omitted in the following description.

As illustrated in FIG. 6, the operator disposes thin plate shims 110 and 120 on a front surface and a back surface of the fiber reinforced plastic member to be formed as the preparation step. Then, after sandwiching the fiber reinforced plastic member S by the thin plate shims 110 and 120, the operator inputs the fiber reinforced plastic member S serving as a workpiece sandwiched by these thin plate shims 110 and 120 into the heating portion 2 from the input port 25 to manufacture the fiber reinforced plastic roll-formed part through the heating, shaping and cooling steps. The fiber reinforced plastic member S discharged out of the cooling portion 4 is completed as a product after removing the thin plate shims 110 and 120 disposed on the front surface and the back surface of the fiber reinforced plastic member as illustrated in FIG. 7.

### Conclusion

The manufacturing method of the fiber reinforced plastic roll-formed part of the present exemplary embodiment includes the preparation step of disposing the thin plate shims 110 and 120 on the front surface and the back surface of the fiber reinforced plastic member S before heating the fiber reinforced plastic plate ‘S in the heating step.

It is possible to suppress orientation of fibers of the fiber reinforced plastic member from being disturbed even if a slip is generated between the forming roller and the fiber reinforced plastic member during a roll-forming process by disposing the thin plate shims 110 and 120 on the front surface and the back surface of the fiber reinforced plastic member serving as the workpiece and by heating and by performing the roll-forming. It is also possible to improve a surface nature of the fiber reinforced plastic roll-formed part by transferring to a metallic mirror surface.

Note that while the cam clutches 313 through 333, 317 through 337, 413 through 453 and 417 through 457 are provided for each of the forming roller pairs 31 through 33 and the cooling rollers 41 through 45 shaping the fiber reinforced plastic member in the present exemplary embodiment, it is unnecessary to provide the cam clutch to the forming roller pairs 31 through 33 and the cooling rollers 41 through 45 in a case where the roll-forming is performed after sandwiching the fiber reinforced plastic member by the thin-plate shims because the surface of the fiber reinforced plastic member is protected by the thin-plate shim.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-26595, filed Feb. 19, 2020, which is hereby incorporated by reference herein in its entirety.

What is claimed is:

1. A roll-forming apparatus comprising:
a heating portion configured to heat a fiber reinforced plastic member; and
a shaping portion disposed downstream of the heating portion in a conveyance direction of the fiber reinforced plastic member to shape the fiber reinforced plastic member heated by the heating portion,
wherein the shaping portion comprises
a first forming roller pair configured to shape the fiber reinforced plastic member by passing the fiber reinforced plastic member heated by the heating portion between rollers of the first forming roller pair, and
a second forming roller pair disposed downstream of the first forming roller pair in the conveyance direction and configured to shape the fiber reinforced plastic member shaped by the first forming roller pair between rollers of the second forming roller pair, and
wherein a rotational speed of the second forming roller pair is set higher than a rotational speed of the first forming roller pair to apply a tension in the conveyance direction to the fiber reinforced plastic member between the first forming roller pair and the second forming roller pair.

2. The roll-forming apparatus according to claim 1, further comprising:
a driving source; and
a torque limiting portion,
wherein the first forming roller pair comprises first and second forming rollers disposed so as to face with each other to shape the fiber reinforced plastic member,
wherein the driving source is configured to rotationally drive the first forming roller, and
wherein the torque limiting portion is configured to limit back torque inputted from the fiber reinforced plastic member to a driving path of the first forming roller.

3. The roll-forming apparatus according to claim 1, further comprising:
a driving source; and
a one-way clutch,
wherein the first forming roller pair comprises first and second forming rollers disposed so as to face with each other to shape the fiber reinforced plastic member,
wherein the driving source is configured to rotationally drive the first forming roller, and
wherein the one-way clutch is disposed in a driving path of the first forming roller and is configured to transmit a rotational force from the driving source in a direction in which the first forming roller rotates in a first direction of conveying the fiber reinforced plastic member downstream in the conveyance direction and to idle in a direction in which the first forming roller rotates in a second direction opposite to the first direction.

4. The roll-forming apparatus according to claim 3, further comprising a one-way clutch disposed in a driving path of the second forming roller and configured to transmit a rotational force from the driving source in a direction in which the second forming roller rotates in a third direction in which the fiber reinforced plastic member is conveyed downstream in the conveyance direction and to idle in a direction in which the second forming roller rotates in a fourth direction opposite to the third direction.

5. The roll-forming apparatus according to claim 1, wherein the shaping portion comprises a heater configured to heat the fiber reinforced plastic member between the first and second forming roller pairs.

6. The roll-forming apparatus according to claim 1 further comprising a cooling portion disposed downstream of the shaping portion,
wherein the cooling portion comprises
an upstream cooling roller pair configured to cool the fiber reinforced plastic member shaped by the shaping portion by passing the fiber reinforced plastic member between rollers thereof, and
a downstream cooling roller pair disposed downstream of the upstream cooling roller pair in the conveyance direction and configured to cool the fiber reinforced plastic member cooled by the upstream cooling roller pair by passing the fiber reinforced plastic member between rollers thereof, and
wherein a rotational speed of the downstream cooling roller pair is set to be higher than a rotational speed of the upstream cooling roller pair to apply a tension in the conveyance direction to the fiber reinforced plastic member between the upstream cooling roller pair and the downstream cooling roller pair.

7. The roll-forming apparatus according to claim 6, further comprising:
a driving source; and
a one-way clutch,
wherein the upstream cooling roller pair includes first and second cooling rollers disposed so as to face with each other,
wherein the driving source is configured to rotationally drive the upstream cooling roller pair, and
wherein the one-way clutch is disposed in a driving path of the first cooling roller and is configured to transmit a rotational force from the driving source in a case where the first cooling roller rotates in a direction of conveying the fiber reinforced plastic member downstream in the conveyance direction and to idle in a case where the first cooling roller rotates in a direction opposite to the direction in which the first cooling roller conveys the fiber reinforced plastic plate downstream in the conveyance direction.

8. The roll-forming apparatus according to claim 7, further comprising a one-way clutch disposed in a driving path of the second cooling roller and configured to transmit a rotational force from the driving source in a case where the second cooling roller rotates in a direction of conveying the fiber reinforced plastic member downstream in the conveyance direction and to idle in a case where the second cooling roller rotates in a direction opposite to the direction in which the second cooling roller conveys the fiber reinforced plastic member downstream in the conveyance direction.

9. A manufacturing method of a fiber reinforced plastic roll-formed part, comprising:
a heating step of heating a fiber reinforced plastic member; and
a shaping step of roll-forming the fiber reinforced plastic member heated in the heating step by a first forming roller pair and a second forming roller pair disposed downstream of the first forming roller pair in the conveyance direction of the fiber reinforced plastic plate and having a rotational speed faster than that of the first forming roller pair while applying a tension to the fiber reinforced plastic member between the first and second forming roller pairs.

10. The manufacturing method of the fiber reinforced plastic roll-formed part according to claim 9, wherein the first forming roller pair comprises first and second forming rollers disposed so as to face with each other to shape the fiber reinforced plastic member, and
wherein a driving path of the first forming roller includes a one-way clutch that is configured to transmit a rotational force from a driving source in a case where the first forming roller rotates in a first direction of conveying the fiber reinforced plastic member downstream in the conveyance direction and to idle in a case where the first forming roller rotates in a second direction opposite to the first direction.

11. The manufacturing method of the fiber reinforced plastic roll-formed part according to claim 9, further comprising a preparation step of disposing shim plates on a front surface and a back surface of the fiber reinforced plastic member before heating the fiber reinforced plastic member in the heating step.
